(19) United States
(12) Patent Application Publication
(10) Pub. No.: US 2016/0303540 A1
(43) Pub. Date: Oct. 20, 2016

(54) APPARATUS AND METHOD FOR HYDROGEN GENERATION AND SYSTEMS INCORPORATING SAME

(71) Applicant: Richard Arthur CHIVERTON, Manchester (GB)

(72) Inventor: Richard Arthur CHIVERTON, Manchester (GB)

(21) Appl. No.: 15/101,789

(22) PCT Filed: Nov. 28, 2014
(86) PCT No.: PCT/GB2014/053547

§ 371 Date: Jun. 3, 2016

(30) Foreign Application Priority Data
Dec. 5, 2013 (GB) 1321509.0

(51) Int. Cl. B01J 19/12; C01B 3/04

(52) U.S. Cl. CPC B01J 19/121; C01B 3/042; B01J 2219/0877; B01J 2219/12

(57) ABSTRACT

A system for the generation of hydrogen at a remote location using energy input to the system at a different, central location, comprises a source of high intensity electromagnetic radiation at the central location, a network of optical cables having a least an input end and an output end, the input end being connected to the electromagnetic radiation from the source, a hydrogen generation apparatus located at the remote location and having an input terminal for receiving light emitted from the other end of the network, the apparatus being adapted in use to split water into hydrogen and oxygen when a catalyst within the apparatus is exposed to radiation from the source supplied by the optical cable network, and a storage chamber for storing the hydrogen produced by the hydrogen generation apparatus.

This invention relates to improvements in apparatus for generating hydrogen at remote locations using centrally generated power. It also relates to various apparatus for use in such a system.

In most climates it is essential to provide heating to domestic dwellings and commercial properties to ensure they maintain a pleasant indoor temperature and to prevent damp from spreading in the property. This heating can be provided in two main ways. Firstly, the heat may be provided by burning highly calorific fuel that it stored at the property. Examples of this form of heating are the burning of wood, coal or oil in domestic and commercial boilers or stoves. Alternatively, the heat may be provided by burning fuel that is continuously supplied to the property along a network of pipes from an energy supplier. An example of this is the heating of property using piped gas. In every one of these cases, fossil fuel is the most common form of highly calorific fuel, and it is widely held that the burning of fossil fuel is bad for the environment. There is also a finite time before fossil fuel resources run out, and so there is an increasing desire to reduce the supply of fossil fuels.

The rooms in a property can each be heated individually. A more common approach is to provide central heating in which the burning of the fuel takes place in one location, such as a boiler room, and used to heat air or water that is pumped around the property to heat each of the rooms. An extension of this scheme is to have a shared boiler room which serves a group of properties, the heated air or water being passed between the boiler and the properties along a network of insulated pipes or ducts. This is known as district heating.

A newly emerging technology is the use of hydrogen as an energy source. It is known to power vehicles using hydrogen. This provides a clean alternative to the use of fossil fuels in vehicles. The vehicles carry a tank which is filled with hydrogen at a filling station. Because hydrogen is provided at these centralised filling stations, they can be refilled using a road tanker which is supplied at a depot. Further extensions of the use of hydrogen as an alternative fuel in the so called hydrogen economy have been hampered by the difficulty of transporting large quantities of hydrogen to the point at which they are required.

According to a first aspect the invention provides a system for the generation of hydrogen at a remote location using energy input to the system at a different, central location, comprising: a source of high intensity electromagnetic radiation at the central location; a network of optical cables having a least an input end and an output end, the input end being connected to the electromagnetic radiation from the source, a hydrogen generation apparatus located at the remote location and having an input terminal for receiving radiation emitted from the other end of the network, the apparatus being adapted in use to split water into hydrogen and oxygen when a catalyst within the apparatus is exposed to radiation from the source supplied by the optical cable network, and a storage chamber for storing the hydrogen produced by the hydrogen generation apparatus.

The electromagnetic radiation may comprise light which may be in at least one of the visible and non-visible spectrum. It may comprise light of a single wavelength or multiple wavelengths.

The light source preferably comprises a laser or multiple lasers. Laser light is preferred as high powers can be generated at a defined wavelengths, compatible with the transmission characteristics of existing low attenuation optical fibres and the chosen catalyst.

The laser source may comprise a high power laser having an average output power of at least 1 mWatt, 1 kWatt or at least 1 Mwatt or more. The laser may be pulsed, in which case each of the pulses of light may exceed this average power. The laser may be connected to the end of the fibre cable network through an appropriate arrangement of optical couplers and lenses.

The laser source may comprise one laser or multiple lasers. Where multiple lasers are used they may be combined into a single beam using appropriate optics or may be applied to the cable network as multiple discrete beams of light.

The network of optical cables may include at least one input optical fibre that is terminated in the vicinity of the source, such as a laser source, to enable light from the laser source to enter the fibre. There may be multiple fibres arranged in parallel. To minimise transmission losses the fibre should have very few impurities and totally internally reflect light at the wavelength emitted by the laser. The fibres may be single mode or multi mode fibres. Becuase the main fibre carrying the laser light does not necessarily carry any information, the primary function is to carry the light with as low a power loss as possible whereas it is not significant if the light beam is distorted as it passes along the fibre.

The cables of the network may also be arranged to carry data across the network to the remote locations.

To provide light to multiple remote units, the network cable may include one or more splitters having an input terminal to which the input optical fibre, or a fibre that is connected to that fibre in series, will be connected, and two or more output terminals, each of which carrying a portion of the light entering the splitter at the input.

The light entering the splitter may be split equally across the output terminals, but could also be split unequally.

A further intermediate cable comprising at least one optical fibre may be connected to the output terminals of the splitter.

The splitter may be located, for example, within a domestic dwelling or industrial building (a shop or factory for instance) to split the light out to multiple hydrogen generation units located around the building. Each hydrogen generation unit could supply power local to the unit in the manner of a conventional ring main and sockets, with a hydrogen generation located in place of a conventional socket.

Each hydrogen generation unit may generate electrical power that is fed to the an electrical socket, allowing a device such as a toaster, kettle, photocopier, computer and the like to be plugged into the socket.

The hydrogen generation apparatus may comprise a housing for a chamber, a catalyst inside the chamber, an inlet suitable for connecting the chamber to a water holding tank or a water supply such as a tap, the chamber also having at least one outlet towards the top through with the gas produced as the water is split can pass.

The process of splitting will cause the deionised H₂O to split into 2H⁺ and O₋₂ , thus, 2H₂O═2H₂+O₂, (if required). The hydrogen is arranged to pass through one outlet and the oxygen through the other. A hydrogen storage tank is connected to one of the outlets into which the hydrogen that is given off is stored.

The inlet may be provided with a valve which can be opened and closed to meter the flow of water into the chamber. The apparatus may include a processor which controls the operation of the valve to regulate the flow of water into the chamber. A level sensor may be provided which outputs a signal indicative of the level of water in the chamber to the processor, the processor in response regulating the flow of water into the chamber.

There are a number of suitable catalysts for splitting water in the presence of light, and the skilled person will have no difficulty in choosing an appropriate catalyst to suit the wavelength of the laser light. For example, one suitable catalyst is NaTaO3:La.

The system may include a heater which receives hydrogen produced by the hydrogen generation apparatus and burns the hydrogen to generate heat. The heater may be combined with a heat exchanger which is exposed to the heat and through which a liquid can be passed, thereby heating the liquid.

The heater and optional heat exchanger may form a central heating boiler for use in heating water for bathing and/or heating a dwelling using one or more radiators. The boiler may be connected to a pump for circulating water around the boiler and radiators.

A battery, capacitor, or supercapacitor, may be provided that is connected to the output of the hydrogen generation or forms an integral part of the hydrogen generation unit. For example it may be located within a housing of the hydrogen generation unit.

The battery, capacitor of super capacitor may store electrical energy for use at times when no light is being transmitted to the unit, or if it is inoperative or simply to help give an additional boost to the amount of energy that can be released at a given time.

The cable network may be terminated at the remote location with a connector. The connector may include a main output port from which the radiation carried across the network is emitted. It may include a further output port from which a part of that radiation may be emitted, allowing the hydrogen generation unit to be connected to one port and a secondary device to the further port. The connector may include a splitter for splitting radiation between the two output ports. The further port may emit a lower proportion of the radiation than the main output port.

The connector may also include a data port which is connected to the cable network. This data port could, however, be made through a discrete connector.

The data port may include means for receiving data from the cable network and also may include means for transmitting data onto the network. The data port may include one or further inlets for receiving data from the remote location, and one or more outlets for outputting data received from the cable network enabling it to function as a modem, router (such as a wireless router), 4G booster, cable television box, games console or audio visual communications device.

The data port may be an integral part of the hydrogen generation unit. It may function as a modem, router or as a cable television box, or as any combination including at least one of the aforesaid.

Where the cable carries data along optical fibres, the data port may include means for converting the received optical signal and converting it into an electronic signal Similarly, it may include means for converting an incoming electronic signal from the remote location into an optical signal that can be injected onto the network. Such opto-electrcal/electro-optical conversion devices are known in the art.

The system may include means for preventing the electromagnetic radiation, for example the light, being passed along the cable network to the hydrogen generating device in the event that an incorrect or incomplete connection is made. This provides for a degree of safety in the system, ensuring laser light cannot escape from the system.

The means for preventing radition passing along the network to the remote location may comprise a processor at the remote location which transmits signals back along the network cable when the hydrogen generating unit is connected, the system including means for allowing laser light to pass along the cable if the signal is present. This means may be provided at the central location or at an intermediate point along the cable network.

The means may prevent radiation reaching the faulty or incorrectly assembled connection whilst allowing radiation to pass through other parts of the cable network.

By preventing radiation passing we may mean preventing any radiation passing along the cable, or only preventing the radiation that is of high power and used to generate the hydrogen. Radiation of a lower power, such as that passing along a data carrying part of the cable and used to carry data, may still be allowed to pass along the network.

The system may be adapted to shut down the laser if an incomplete connection or missing connection is indicated.

The means for preventing radition passing through the network to the remote location may also include a means for passing data along the cable to the remote location and means for detecting a response. Therefore a two way check, such as a handshake, may be implemented. Only if a correct response is received will the system consider it safe to allow high power light along the cable to the remote unit.

The means for preventing radiation passing along the network to the remote location may be implemented using one or more processing devices which may run programmes stored in a local memory. The processors may draw power from the cable network or from an internal or external supply such as a battery or a connection to a distributed electrical supply or other external power source.

The means from preventing light causing damage when an incorrect connection is made may additionally or alternatively be integrated into a connector that may be present anywhere along the cable network. The connector will comprise two parts that are joined to make the connection. The means for preventing damage may comprise a first section that is included in one part of the connector and a second section that is included in the other part, the two sections exchanging data when connected, and the means only permitting light to pass through the connector if the exchanged data indicates a safe connection.

The exchanged data may pass from one section to the other, or between both sections as part of a two way handshake.

The connector may include a shutter that is normally closed and which is only opened when the exchanged data indicates a sound connection has been made. Alternatively or additionally, the means may generate signals which are transmitted to the laser source that stop the laser source transmitting light into the cable if it is not safe. This transmission may be made along the network cable or by other means, e.g. wirelessly.

The system may include multiple hydrogen generation units, each located at a different remote location, and the cable network may include at least one cable connecting each hydrogen generation apparatus to the source across the network. As indicated above, these may be distributed at the district level, with one per district of houses or buildings, or at a block level, street level, per house level, or even multiple units for each building.

The system may therefore be arranged to provide hydrogen to multiple domestic dwellings. Thus, each remote location may comprise a domestic dwelling such as a house or flat. The source will be provided some distance from the dwelling at a central location. For instance, the dwellings may form a part of a town or village, and the source may be located at a convenient location for connecting to the village by the cable network. Where each dwelling is a flat, one source may be used to provide each flat in a block with hydrogen, or only a subset of the flats. The source may be located within the block or some distance from the block. It may provide hydrogen to more than one block, or to one block and some other dwellings.

The network cables may be buried under the streets or pavements leading to the dwellings. They may extend for several tens, or hundreds, of metres, or for several kilometres, so that the spacing between the source and remote location can vary from a few metres to many kilometres depending on the specification of the system.

Most if not all dwelling nowadays already have a water supply. To implement the system all that would be needed is to connect each dwelling to a cable of the cable network. In many parts of the world this can be achieved relatively easily by replacing existing copper cables used to carry telecommunications signals with the cables of the inventive system. In many cases ducts along which the cables can be laid are already in place, making the task quite simple.

The number of dwellings that can be supplied from one central source will depend on the power of the laser source and the rate of required production of hydrogen at each dwelling. The rate of required production will depend on what the hydrogen is to be used for. For instance, it could be used to heat the dwelling and so a larger dwelling will need more heat assuming a standard level of insulation for all dwellings. If the hydrogen is also to be used to make electricity or to fuel hydrogen powered vehicle, more hydrogen produced at a higher rate may be needed.

It is envisaged that at least two, or at least ten, or perhaps 1000 or more dwellings may be supplied from one central location with a source.

The source, if it is a laser source, will itself require a supply of electricity. This can be produced cleanly and safely using any of the emerging green technologies such as solar power, wind power or wave power. Nuclear power could be used which also has the benefit that it is not consuming fossil fuel—or direct concentrated sunlight—perhaps focused from a solar array into a concentrated point then distributed itself via the optical fibre network, perhaps having it's wavelength modified to an optimum at some point in this process before being distributed to the remote locations. Also light produced directly in a nuclear fusion or fission reaction, entering the network, being modulated to an optimum wavelength as required (using waveshifters and/or filters), and then being distributed to a remote location. This could enable neutron production from the fusion reaction to be used solely for a district heating type scenario, instead of heating water to turn to steam, to then turn to electricity, etc.

In an alternative use, the system may be implemented on a smaller scale to provide hydrogen at different locations within a factory or holiday complex, with an industrial site or building, or within a car, lorry, satellite, (space) ship or submarine, or on an even smaller scale at different locations within a machine such as a computer or small electrical/optical devise to include a molecule or small robot. There may be benefits to transmitting the energy in the form of light and producing hydrogen locally to where it is required, and or combining hydrogen and oxygen into electricity via fuel cell.

On a small scales, thee network element of the system may be arranged to allow quantum computers to talk to each other, transmitting the light through the optical fibre, with a transfer rate up to and in excess of 2 TB/s into wherever there is a unit at a remote location. The system may therefore include one or more quantum switches that control the flow of light around the system, and may form the basis of a quantum computer that is powered by the light transmitted through the cables.

According to a second aspect the invention provides a hydrogen generation apparatus for use in the system of the first aspect.

The hydrogen generation apparatus may have any of the features described in association with the whole system above.

According to a third aspect the invention provides a connector for connecting a cable of the network of the first aspect to a hydrogen generating unit or to another cable of the network, the connector including means for preventing radiation from the source passing across the connector if the connection is not correctly made.

The connector may include any of the features described above in relation to the whole system.

According to a fourth aspect the invention provides a method of supplying hydrogen to a dwelling or commercial property for use in the hydrogen economy comprising:

provides a system for the generation of hydrogen at a remote location using energy input to the system at a different, central location, comprising:

generating laser light using a source of laser light provide at a central location;

transporting the light across a network of optical cables having a least an input end and an output end, the input end being connected to the source of laser light, causing the light transported across the network to illuminate a hydrogen generation apparatus located at the remote location and having an input terminal for receiving light emitted from the other end of the network, the apparatus being adapted in use to split water into hydrogen and oxygen when a catalyst within the apparatus is exposed to light from the laser source supplied by the optical cable network in the presence of the light received at the input terminal,

The method may comprise storing the hydrogen in a chamber prior to use.

The method may comprise transporting the light to multiple remote locations and generating hydrogen at each location.

The method may also comprise transporting data across the cable network to the remote locations. The method may transport the light and data across a common network.

The method may also comprise transmitting safety information across the parts of the network carrying data, the signals indicating whether it is safe to carry the light across the network.

The method may comprise generating safety signals at each connection between one cable of the network and another cable, and/or at each connection between the cable network and the remote location.

There will now be described, by way of example only, several embodiments that fall within the scope of one or more of the aspects of the invention, with reference to the accompanying drawings of which:

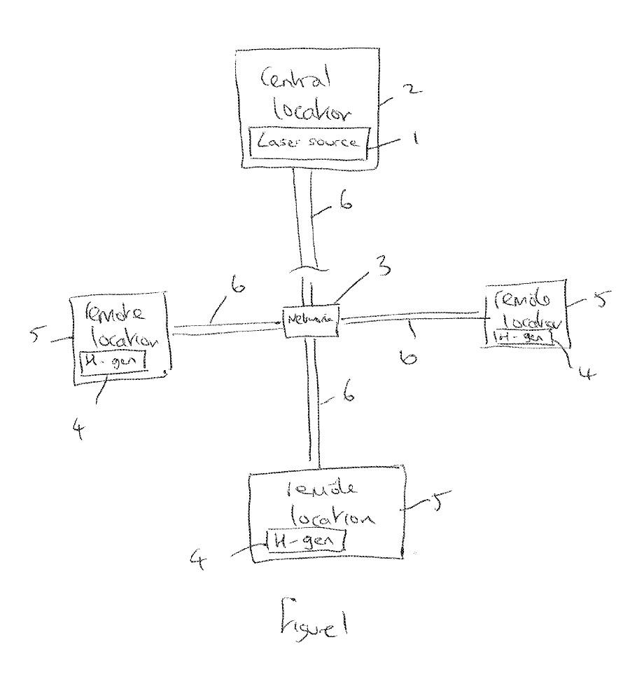

FIG. 1 is a schematic of a system for generating hydrogen which incorporates features that fall within the scope of the first aspect,

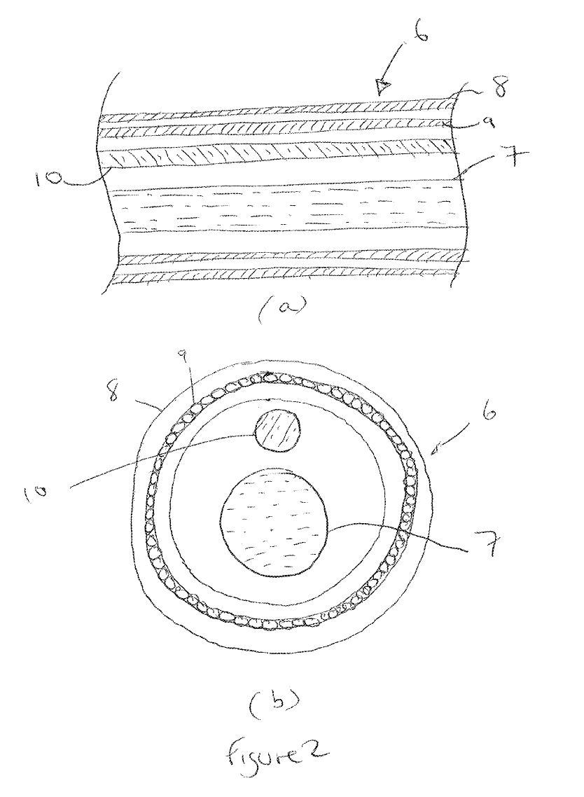

FIG. 2 (a) and (b) is a view in plan and in cross section of a length of cable 6 that is used to form the cable network;

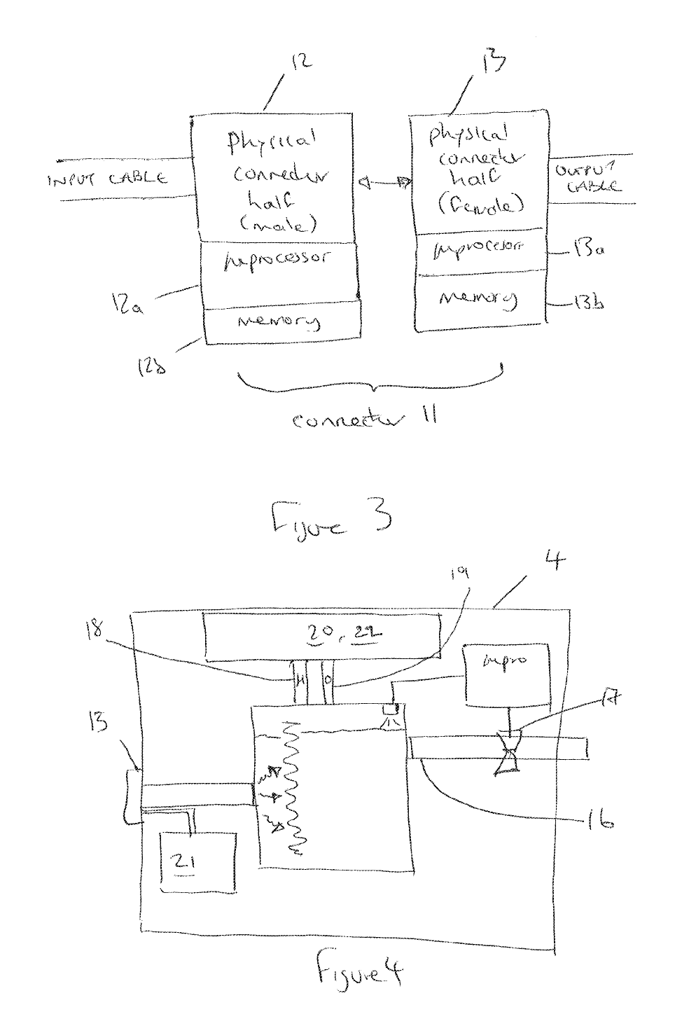

FIG. 3 is a schematic of a connector that is used to join cables and cable to hydrogen generation unit in the network of FIG. 1; and

FIG. 4 is a schematic of the key parts of the hydrogen generation unit that can be located at each remote location.

FIG. 1 shows a system for the combined distribution of power and data from a central location to a set of remote locations. In this example, the remote locations are domestic dwellings such as detached houses, semi-detached houses, terraced houses, and flats or apparatments located around a town or village. These may be located many hundreds or thousands of metres away from the central location. By central location we do not mean that it is geometrically at the centre of the remote locations, merely that it is a common location from which each remote location is served.

In this example, the source comprises a light source such as a laser. The invention should not be limited to laser sources, and other sources of radiation could be provided.

The system comprises several key parts:

A light source 1 such as a laser located at the central location 2;

An optical fibre cable network 3 that connects the central location to each of the remote locations and which also carries data signals; and

A remotely located heat/power and data unit, the “H-gen” apparatus 4 at each of the remote locations 5.

The principle of operation of the system is that energy, in the form of laser light, is generated at the central location 2 and carried along the cable network 3 to the remote locations 5. There it is shone upon the hydrogen generation unit 4 which uses the energy of the light to split water into hydrogen and oxygen. This gas can then be burnt at a later time to generate heat, or recombined into H₂O in the fuel cell element contained within the system to generate electricity, either for storage in an internal capacitor or for immediate use internally or externally of the unit, within the remote location, or a combination of both being stored and used immediately according to demand from apparatus connected to the electrical (power demand) network external to the devise yet in the vicinity of the remote location. This heat may then be used to heat the remote location, and the electricity may be used to power electronic devices relying on electrons running through a metal wire or ceramic composite or other medium for the transfer and production of electricity within the remote location

The invention therefore consists of a system comprising at least three parts, whereby power, heat and data are transported over a combined heat, power, data cable comprising of an optical fibre bundle, including at least one signal carrier optical fibre strands for status monitoring of the system. Significantly, the same cable network that carries the optical power also carries data to and from the remote location. This can be used to supply telecommunication signals for voice and video communications, television signals for digital television, and also internet data signals for connection of the domestic dwellings to the internet, or World Wide Web, network of computers, and or to include quantum/biological computers. The ability to perform both functions on a single cable network is considered to be an especially desirable feature of this embodiment of the present invention.

FIG. 2 shows a typical section of a cable 6 that can be used in the network. The cable comprises a main optical fibre or fibre bundle 7 that is surrounded by a protective sheath 8. This main fibre carries the high power laser light to the remote locations. The sheath 8 is reinforced with elongate steel cables 9 that are wounded around the fibre. Also within the sheath is a second fibre 10 which is used to carry data to the remote locations and back from the remote locations. In some arrangements this second fibre may instead be a metal conductive wire. It may even be possible for the data to be carried along the same fibre as the high power optical light used to generate hydrogen (as will be explained) using appropriate wavelengths of light or appropriate modulation of the light signals.

In a practical network, multiple cables 6 will be provided which branch off from the network to supply multiple remote locations as shown in FIG. 1 for example. The cable network comprises two branch arm, one supplying a first dwelling at a remote location and a second supplying a second dwelling at a second location. These are spliced together using an optical splitter onto a single cable that connects back to the central location.

FIG. 3 shows a connector (port) 11 used to connect two lengths of the cable 6 together. As a safety feature, the connector will have a twist and click type mechanism so that only one thing can be plugged in and allow power, data etc. through the cable, the system roughly centring around the alignment of signal cables so the system knows that it is plugged in both ends and can now safely transmit the laser light.

The connector has two halves 12, 13, one connected to one fibre length and the other to the other fibre length. One of these halves may also be integrated into the hydrogen generation unit provided at the remote location to allow the network to be connected to the hydrogen generation unit.

Each half of the connector may include a microprocessor 12a, 13a and a memory 12b, 13b which stores program instructions that can be executed by the microprocessor. The microprocessors in each half of the connector exchange data with the other half of the connector, either wirelessly using an optional wireless transceiver or by sending and receiving signals along the cable network across the connection. Each processor checks for the presence of the signal from the other, and when the signals indicate that the connection has been safely made the connector transmits a further signal back along the cable network (or wirelessly) to the central location. A further processor at the central location checks this received signal. Only if the received signal indicates that a correct connection has been made will laser light be passed along the cable to the connector.

FIG. 4 shows the remote unit itself, comprising of the laser light strand or strands of the fibre optic cable being used, which terminate at the connector half 13 so that the light leaves the fibres and strikes a catalyst 14 inside a chamber 15. The chamber 15 has an inlet 16 connected to a water holding tank (not shown) or a water supply such as a tap. The inlet 16 is provided with a valve 17 which can be opened and closed to meter the flow of water into the chamber. The chamber 15 also has two outlets 18, 19 towards the top through with the gas produced as the water is split can pass. This process of splitting will cause the deionised H₂O to split into 2H+ and O−2. The hydrogen is arranged to pass through one outlet and the oxygen through the other. A hydrogen storage tank 20 is connected to one of the outlets into which the hydrogen that is given off is stored.

The hydrogen in the storage tank 20 can be vented off through another outlet to be used to refill a hydrogen powered car. Alternatively, it may be fed from the tank into a combustion chamber where it may be exposed to a naked flame so that it is burnt inside the unit for the generation of heat (to heat a home as an example, but not limited to home use) and may be used as a fuel for an oven or stove to cook on. Again, inside the home. This system may, in at least one arrangement, be seen as a replacement for the conventional gas fired boiler, to do all of this in one compact and safe unit. In other arrangements, the unit may through the recombination of oxygen and hydrogen be used to produce electricity and water. The electricity can be stored in capacitors or batteries or other energy storage devices for subsequent use at times of peak demand or to be used immediately in the remote location.

As described the cable network 4 can also carry data to the remote location and back to the central location. The cable 6 that enters the remote location will be terminated by the connector 11 so that a data connection is made to the hydrogen generation unit 4. The data strands from the cable connect to cable inside the unit will then be used as standard fibre to the home optical fibre data transmission. The unit 4 will comprise internally of a modem 21 to allow processing of this signal and output externally of the unit via RJ45 Ethernet connection or other standard connector. This connection may be used to handle all communications into and out of the home, including fibre optic broadband, television streaming, phone line communication and everything else you would need to transfer data into and out of the home for.—Including status monitoring for smart homes connected to a smart grid.

An oxygen storage tank 22 may also be provided. The hydrogen and oxygen, stored in two small separate tanks internally, can also be recombined as in a traditional fuel cell to produce electricity on demand to power applications within the home, but not limited to a home use. (Satellites being one example). The unit will continue to generate hydrogen slowly all the time until the unit tells the system that it is full. Capacitors will need to be included in the unit for the storage of electricity to cope with spikes in demand for electrical power, as the generation of the electricity from the full cell will be a slow and steady affair. The H₂O from the recombination of hydrogen and oxygen in the unit, either from the fuel cell reaction or from the burning process, is then recycled internally to be stored and split into hydrogen and oxygen again using the laser light. And thus, the system continues. The amount of light and/or data being transmitted through the unit/connector will be monitored to allow for correct billing according to use. A nozzle on the unit will be installed at time of production to allow for refilling of deionised water in case the system gets low for any reason with use. This system can be topped up with deionised water easily, or normal water with the addition of an internal deioniser attachment, using an inlet in the unit at either high pressure or under standard conditions.

The example shown in the drawings is for a system that is primarily for the home generation and storage of hydrogen to be used in the hydrogen economy. However, there are obvious industrial uses to scale up the design for grid infrastructure and transmission of energy and data, also required to allow the system to catch on. Satellites, space industry, (using light from a solar array focused into the unit; to provide heat/power and or transmit data across space for a satellite or space station).

A scaled down system can be provided in which the central and remote locations may be very close to one another, for instance within a few metres or centimetres. For example, a scaled down version could be incorporated with an electronic device such as a standard computer, or a compute network that may include or be comprised solely of a single biocomputer or network of, or quantum computer, or network of, or any combination of the aforesaid to include any compute devise powered by or obtaining its data from an optical source or energy source emitting electromagnetic radiation with the intended purpose of carrying out an intended calculation or deriving power from such a source, or power source that results in such an optical source being transmitted to the network or a single compute devise, such as a temporary energy storage devise including but not limited to a stored plasma.

On a slightly larger scale, the system could be incorporated into a motor vehicle, or ship or submarine. The light passing around the vehicle along the cable network is used to generate hydrogen at a number of remote units located in the vehicles and electronic devises for the transmission of data and power around a devise, perhaps including a microprocessor and or/quantum computing system.

1-26. (canceled)

27. A system for the generation of hydrogen at a remote location using energy input to the system at a different, central location, comprising:
a source of high intensity electromagnetic radiation at the central location;
a network of optical cables having a least an input end and an output end, the input end being connected to the electromagnetic radiation from the source,
a hydrogen generation apparatus located at the remote location and having an input terminal for receiving light emitted from the other end of the network, the apparatus being adapted in use to split water into hydrogen and oxygen when a catalyst within the apparatus is exposed to radiation from the source supplied by the optical cable network,
and a storage chamber for storing the hydrogen produced by the hydrogen generation apparatus.

28. The system according to claim 27 in which the source comprises a light source and in which the electromagnetic radiation produced by the source comprises light in at least one of the visible and non-visible spectrums.

29. The system according to claim 28 in which the light source comprises a laser or multiple lasers, or a nuclear fission or nuclear fusion reactor.

30. The system according to claim 27 in which the network of optical cables includes at least one input optical fibre that is terminated in the vicinity of the source to enable light from the source to enter the fibre.

31. The system according to claim 30 in which the optical cables in use also carry data across the network to the remote locations.

32. The system according to claim 27 in which the hydrogen generation apparatus comprises a housing for a chamber, a catalyst inside the chamber, an inlet suitable for connecting the chamber to a water holding tank or a water supply, the chamber also having at least one outlet towards the top through with the gas produced as the water is split can pass.

33. The system according to claim 27 which further comprises a heater which receives hydrogen produced by the hydrogen generation apparatus and burns the hydrogen to generate heat, wherein the heater optionally forms a central heating boiler for use in heating water for bathing and/or heating a dwelling using one or more radiators.

34. The system according to claim 27 which includes a data port which is connected to the cable network, the data port including means for receiving data from the cable network and means for transmitting data onto the network, the data port including one or more inlets for receiving data from the remote location, and one or more outlets for outputting data received from the cable network enabling it to function as a modem, router, cable television box, games console or audio visual communications device at the remote location.

35. The system according to claim 27 which includes means for preventing the electromagnetic radiation, such as light, being passed along the cable network to the hydrogen generating device in the event that an incorrect or incomplete connection is made in the network.

36. The system according to claim 35 in which the means for preventing the radiation being transmitted comprises a processor at the remote location which transmits signals back along the network cable when the hydrogen generating unit is connected, the system including means for allowing radiation to pass along the cable to the remote location only if the signal is present.

37. The system according to claim 35 in which the means from preventing radiation passing across the network is at least partially integrated into a connector that may be present along the cable network, the means comprising a first part that is included in one part of the connector and a second part that is included in the other part, the two parts of the means exchanging data when connected, and the means only permitting radiation to pass through the connector if the exchanged data indicates a safe connection.

38. The system according to claim 27 which includes multiple hydrogen generation units, each located at a different remote location, and the cable network includes at least one cable connecting each hydrogen generation apparatus to the source across the network, optionally wherein at least one of the hydrogen generating apparatuses is located at a remote location comprising a residential dwelling, further optionally in which the remote locations comprises different locations within a factory or holiday complex, with an industrial site or building, or within a car, lorry, satellite, (space)ship or submarine, the cable network connecting a hydrogen generating apparatus at each location to the common source.

39. The system according to claim 27 in which a plurality of hydrogen generation units are distributed around a building connected by cables to the source of radiation, the output of the units being connected to sockets suitable for receiving an electrical plug.

40. The system according to claim 27 in which the hydrogen generation unit includes a battery, capacitor or supercapacitor for storing electrical energy.

41. The system according to claim 27, further comprising a connector for connecting a cable of the network to a hydrogen generating unit or to another cable of the network, the connector including means for preventing radiation from the source passing across the connector if the connection is not correctly made.

42. A method of supplying hydrogen to a dwelling or commercial property for use in the hydrogen economy comprising:
providing a system for the generation of hydrogen at a remote location using energy input to the system at a different, central location;
generating electromagnetic radiation, such as light, at a central location;
transporting the radiation across a network of optical cables having a least an input end and an output end, the input end being connected to the source of radiation,
causing the radiation transported across the network to impinge upon a hydrogen generation apparatus located at the remote location and having an input terminal for receiving radiation emitted from the other end of the network, the apparatus being adapted in use to split water into hydrogen and oxygen when a catalyst within the apparatus is exposed to the radiation from the source supplied by the cable network.

43. The method according to claim 42 comprising storing the hydrogen in a chamber prior to use.

44. The method according to claim 42 comprising transporting the radiation to multiple remote locations and generating hydrogen at each location.

45. The method according to claim 42 further comprising transporting data across the cable network to the remote locations across the cable network and optionally further comprising transmitting safety information across the parts of the network carrying data, the signals indicating whether it is safe to carry the radiation from the source across the network.
